(19) United States
(12) Patent Application Publication
(10) Pub. No.: US 2008/0212673 A1
(43) Pub. Date: Sep. 4, 2008

(54) Systems and Methods for Adaptively Determining I Frames for Acquisition and Base and Enhancement Layer Balancing

(76) Inventor: Peisong Chen, San Diego, CA (US)

Correspondence Address: QUALCOMM INCORPORATED, 5775 MOREHOUSE DR., SAN DIEGO, CA, 92121, US

(21) Appl. No.: 11/837,062

(22) Filed: Aug. 10, 2007

Related U.S. Application Data
(60) Provisional application No. 60/892,337, filed on Mar. 1, 2007.

(51) Int. Cl. H04N 7/26

(52) U.S. Cl. 375/240.02; 375/E07.127

(57) ABSTRACT

The invention includes apparatus, systems and methods for processing multimedia data. A method of processing multimedia data may include encoding a frame of the multimedia data as an I frame, a channel switch frame, and a P frame and selecting the encoded I frame if a size of the encoded I frame and a size of the encoded channel switch frame and the encoded P frame meet a first condition. An apparatus for processing multimedia data may include an encoder for encoding a frame of the multimedia data as an I frame, a channel switch frame, and a P frame and selecting the encoded I frame if a size of the encoded I frame and a size of the encoded channel switch frame and the encoded P frame meet a first condition.

### CLAIM OF PRIORITY UNDER 35 U.S.C. §119

The present Application for Patent claims priority to Provisional Application No. 60/892,337 entitled “SYSTEMS AND METHODS FOR ADAPTIVELY DECIDING I FRAMES FOR ACQUISITION AND BASE AND ENHANCEMENT LAYER BALANCING,” filed Mar. 1, 2007, and assigned to the assignee hereof and hereby expressly incorporated by reference herein.

### BACKGROUND

1. Field

The invention relates to encoding of multimedia data that may include audio data, video data or both. More particularly, the invention relates to adaptively determining I frames for acquisition and base and enhancement layer balancing.

2. Background

Multimedia data can be audio data, video data, or a combination of audio and video data. Multimedia data includes a number of bits that represent one or more frames or pictures. The multimedia data begins with an I frame (intra-coded frame), and is followed by one or more B frames (bi-directional frames) or P frames (predictive frames). Generally, an I frame stores all the data for displaying the frame, a B frame relies on data in one or more preceding and/or subsequent frames (e.g., may only contain data changed from the preceding frame or is different from data in the subsequent frame), and a P frame contains data that has changed from the preceding frame. In common usage, I frames are interspersed with B frames and P frames in encoded multimedia data. In terms of size (e.g., the number of bits used to encode the frame), I frames are typically larger than P frames, which in turn are typically larger than B frames.

Multimedia data can be divided into different shots (or scenes). A shot is a video sequence that has continuous video frames for one action. A scene change occurs when two consecutive frames produce different images or scenes. A scene change can be detected using a number of scene change algorithms and can be an important part of the efficient encoding of multimedia data. A scene change occurs when a frame in a series of frames has data that indicates a different scene when compared to a previous frame. Generally, the series of frames may not have significant changes in any two or three (or more) adjacent frames, or there may be slow changes, or fast changes.

When a scene is not changing significantly, an I frame followed by a number of B frames and P frames can sufficiently encode the video so that subsequent decoding and display of the multimedia data is visually acceptable. However, when a scene is changing significantly, either abruptly or slowly, additional I frames and less predictive encoding (B frames and P frames) are used to produce subsequently decoded visually acceptable results. Since the content of a frame classified as an abrupt scene change is different from that of the previous frame, an abrupt scene change frame should typically be encoded as an I frame. However, since scene change detection is not always accurate, improvements in deciding whether to encode the multimedia data as an I frame, a B frame or a P frame can improve the coding efficiency (i.e., decrease the number of bits being encoded).

### SUMMARY

The invention includes apparatus, systems and methods for processing multimedia data. A method of processing multimedia data may include encoding a frame of the multimedia data as an I frame, a channel switch frame, and a P frame and selecting the encoded I frame if a size of the encoded I frame and a size of the encoded channel switch frame and the encoded P frame meet a first condition.

An apparatus for processing multimedia data may include an encoder for encoding a frame of the multimedia data as an I frame, a channel switch frame, and a P frame and selecting the encoded I frame if a size of the encoded I frame and a size of the encoded channel switch frame and the encoded P frame meet a first condition.

An apparatus for processing multimedia data may include means for encoding a frame of the multimedia data as an I frame, a channel switch frame, and a P frame. The means for encoding may also encodes a frame of the multimedia data as a B frame, creates a first base layer data packet and a first enhancement layer data packet using at least one of the encoded I frame or the encoded B frame and creates a second base layer data packet and a second enhancement layer data packet using at least one of the encoded P frame or the encoded channel switch frame. The apparatus may also include means for selecting the encoded I frame if a size of the encoded I frame and a size of the encoded channel switch frame and the encoded P frame meet a first condition.

A machine-readable medium may include instructions for processing multimedia data, the instructions upon execution cause a machine to encode a frame of the multimedia data as an I frame, a channel switch frame, and a P frame and select the encoded I frame if a size of the encoded I frame and a size of the encoded channel switch frame and the encoded P frame meet a first condition.

### BRIEF DESCRIPTION OF THE DRAWINGS

The features, objects, and advantages of the invention will become more apparent from the detailed description set forth below when taken in conjunction with the drawings, wherein:

FIG. 1 is a block diagram of a system for encoding and decoding multimedia data;

FIG. 2 is a block diagram of an encoding apparatus configured to operate in a nonlayered mode;

FIGS. 3A and 3B are a flow chart of a method of selecting multimedia data for acquisition in a nonlayered mode;

FIG. 4 is a block diagram of an encoding apparatus configured to operate in a layered mode;

FIGS. 5A, 5B and 5C are a flow chart of a method of selecting multimedia data for acquisition in a layered mode;

FIG. 6 is an exemplary base layer and enhancement layer configurations based on the encoding method;

FIG. 7 is a table showing an encoding order, a display order, a P frame size, and a B frame size for a number of encoded frames; and

FIG. 8 is a table illustrating the number of bytes produced in the base layer and the enhancement layer when forcing a normal I frame encoding method and without forcing a normal I frame encoding method.

### DETAILED DESCRIPTION

Apparatus, systems and methods that implement the embodiments of the various features of the invention will now be described with reference to the drawings. The drawings and the associated descriptions are provided to illustrate some embodiments of the invention and not to limit the scope of the invention. Throughout the drawings, reference numbers are re-used to indicate correspondence between referenced elements. In addition, the first digit of each reference number indicates the figure in which the element first appears.

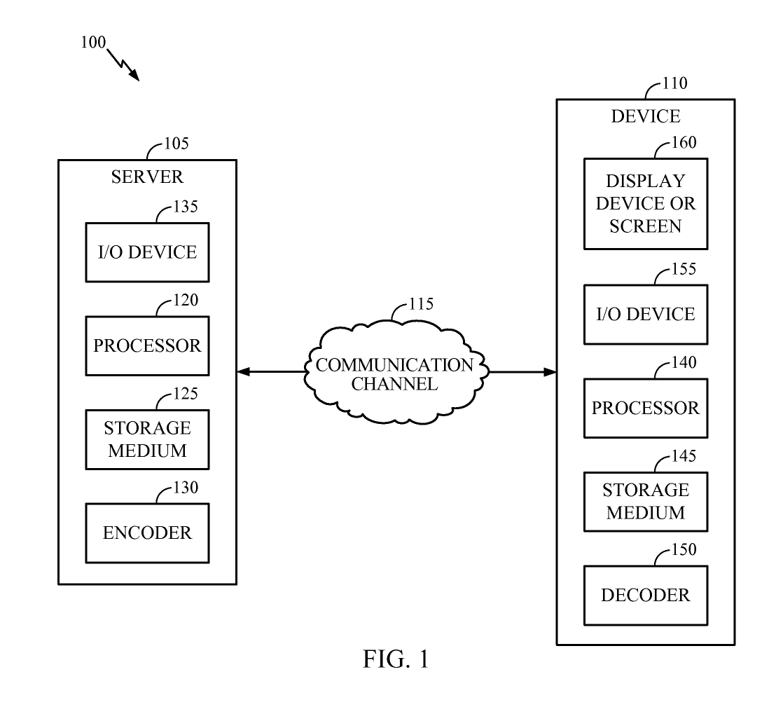

FIG. 1 is a block diagram of a system 100 for encoding and decoding multimedia (e.g., video, audio or both) data. The multimedia data may be in the form of a series of pictures or video frames. System 100 may be configured to encode (e.g., compress) and decode (e.g., decompress) multimedia data. System 100 may include a server 105, a device 110, and a communication channel 115 connecting server 105 to device 110. System 100 may be used to illustrate the methods described below for encoding and decoding multimedia data. System 100 may be implemented using hardware, software, firmware, middleware, microcode, or any combination thereof. One or more elements can be rearranged and/or combined, and other systems can be used in place of system 100 while still maintaining the spirit and scope of the invention. Additional elements may be added to system 100 or may be removed from system 100 while still maintaining the spirit and scope of the invention.

Server 105 may include a processor 120, a storage medium 125, an encoder 130 and an I/O device 135 (e.g., a transceiver). Processor 120 and/or encoder 130 may be configured to receive multimedia data in the form of a series of pictures or video frames. Processor 120 and/or encoder 130 may be an Advanced RISC Machine (ARM), a controller, a digital signal processor (DSP), a microprocessor, or any other device capable of processing multimedia data. Processor 120 and/or encoder 130 may transmit the multimedia data to storage medium 125 for storage and/or may encode the multimedia data. Storage medium 125 may also store computer instructions that are used by processor 120 and/or encoder 130 to control the operations and functions of server 105. Storage medium 125 may represent one or more devices for storing the multimedia data and/or other machine readable mediums for storing information. The term “machine readable medium” includes, but is not limited to, random access memory (RAM), flash memory, read-only memory (ROM), EPROM, EEPROM, registers, hard disk, removable disk, CD-ROM, DVD, wireless channels, and various other mediums capable of storing, containing or carrying instruction(s) and/or data.

Encoder 130, using computer instructions received from storage medium 125, may be configured to perform both parallel and serial processing (e.g., encoding) of the multimedia data. The computer instructions may be implemented as described in the methods below. Once the multimedia data is encoded, the encoded multimedia data may be sent to I/O device 135 for transmission to device 110 via communication channel 115.

Device 110 may include a processor 140, a storage medium 145, a decoder 150, an I/O device 155 (e.g., a transceiver), and a display device or screen 160. Device 110 may be a computer, a digital video recorder, a handset device (e.g., a cell phone, mobile unit, Blackberry, iPhone, etc.), a set top box, a television, and other devices capable of receiving, processing (e.g., decompressing) and/or displaying multimedia data. I/O device 155 receives the encoded multimedia data and sends the encoded multimedia data to the storage medium 145 and/or to decoder 150 for decompression. Decoder 150 is configured to reproduce the multimedia data using the encoded multimedia data. Once decoded, the multimedia data can be stored in storage medium 145. Decoder 150, using computer instructions retrieved from storage medium 145, may be configured to perform both parallel and serial processing (e.g., decompression) of the encoded multimedia data to reproduce the series of pictures or video frames. The computer instructions may be implemented as described in the methods below. Processor 140 may be configured to receive the multimedia data from storage medium 145 and/or decoder 150 and to display the multimedia data on display device 160. Storage medium 145 may also store computer instructions that are used by processor 140 and/or decoder 150 to control the operations and functions of device 110.

Communication channel 115 may be used to transmit the encoded multimedia data between server 105 and device 110. Communication channel 115 may be a wired connection or network and/or a wireless connection or network. For example, communication channel 115 can include the Internet, coaxial cables, fiber optic lines, satellite links, terrestrial links, wireless links, other media capable of propagating signals, and any combination thereof.

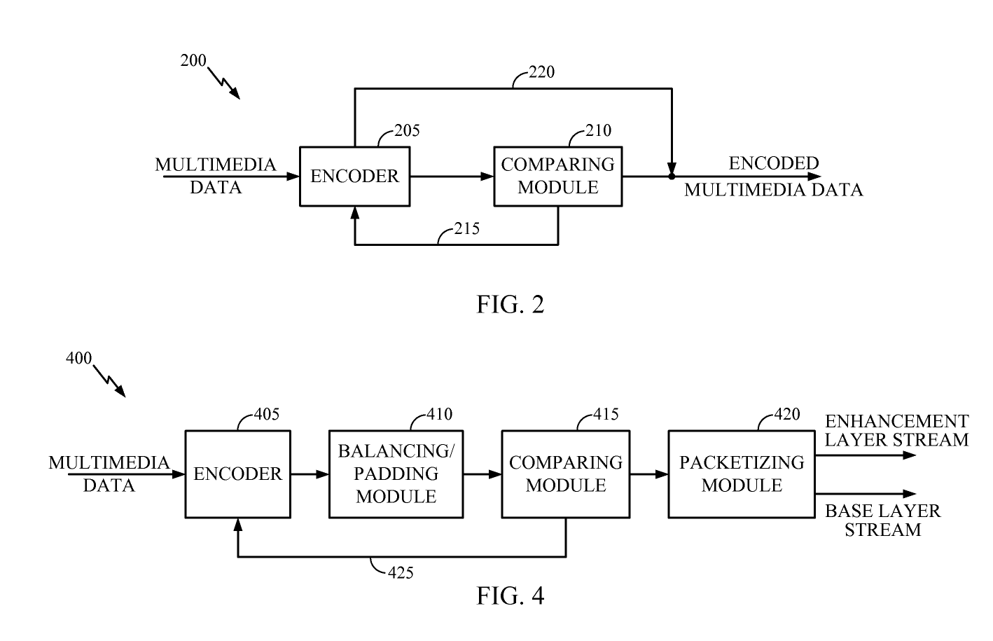

FIG. 2 is a block diagram of an encoding apparatus 200 configured to operate in a nonlayered mode. Encoding apparatus 200 may be substituted in place of or may be part of encoder 130 of FIG. 1. In the nonlayered mode, a single layer is used for the multimedia data and the frames may be grouped in a packet format (e.g., a superframe). Encoding apparatus 200 may include an encoder 205 and a comparing module 210. A feedback loop 215 coupled between encoder 205 and comparing module 210 allows for multi-pass (e.g., 2 pass) encoding and transcoding. In multi-pass encoding or transcoding, encoder 205 has information about the complexity of each frame before the second pass encoding or reencoding. A feed forward loop 220 coupled to encoder 205 allows the encoded multimedia data to skip comparing module 210 during the second and subsequent passes.

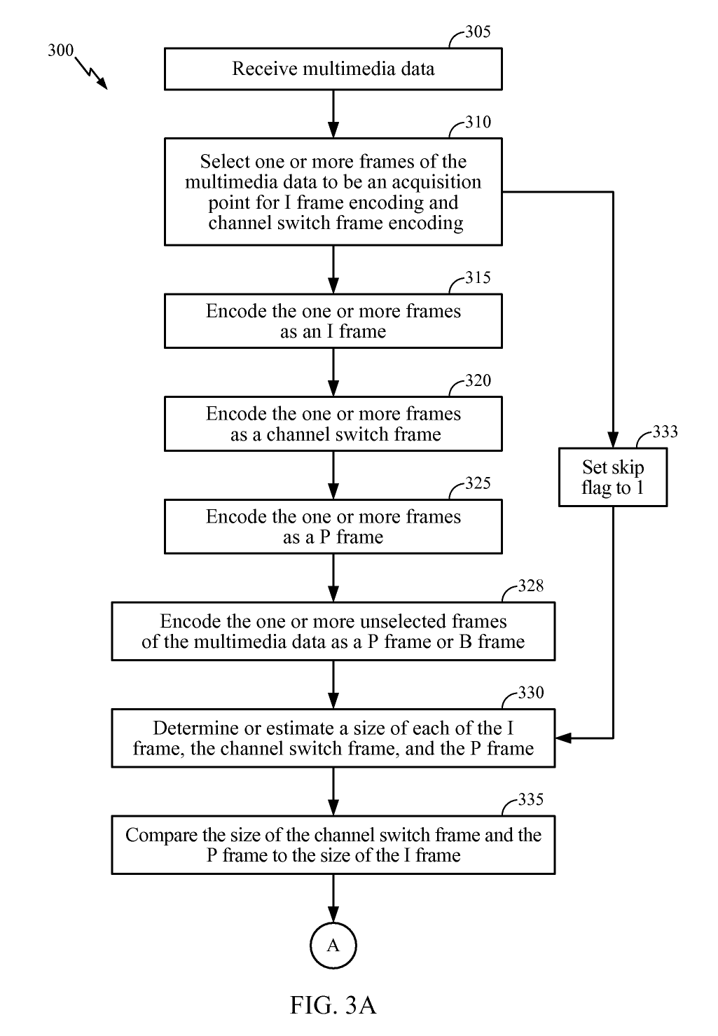

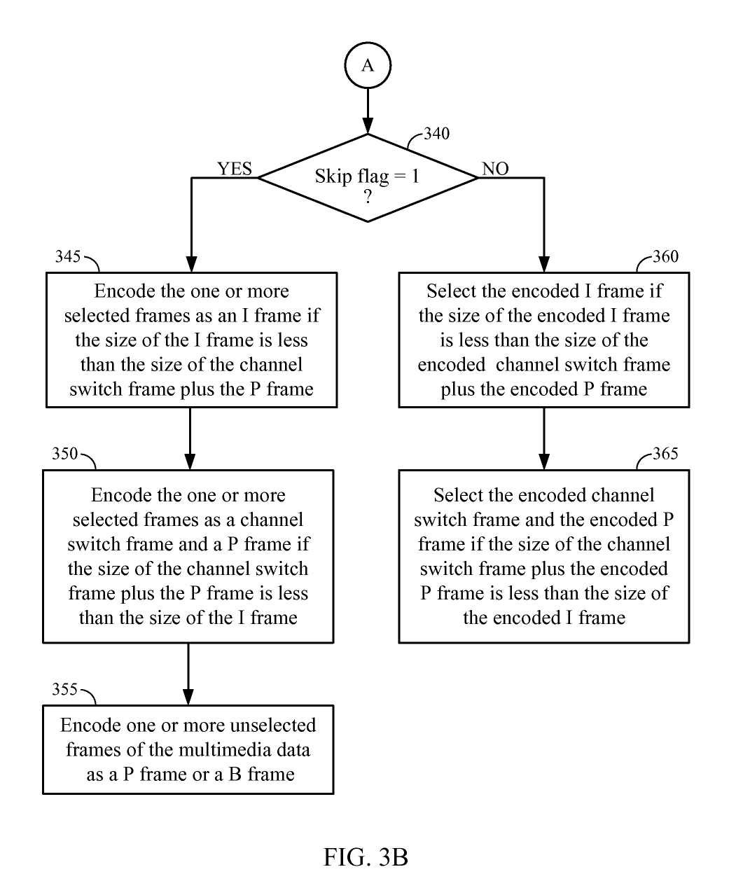

FIGS. 3A and 3B are a flow chart of a method of selecting multimedia data for acquisition in a nonlayered mode. Referring to FIGS. 2, 3A and 3B, the multimedia data is received by encoder 205 in the form of a stream of bits (block 305). The stream of bits may be grouped or organized as one or more superframes. In one embodiment, a superframe is equivalent to about 1 second of multimedia data. For example, each superframe may have 1, 12, 15, 24, 30 or 60 frames or other number of frames depending on the frame rate of the multimedia data. The term “frame” can be replaced with the term “superframe” in this disclosure and the terms can be used interchangeably throughout the disclosure. The term “size” can be replaced with the term “superframe size” in this disclosure and the terms can be used interchangeably throughout the disclosure. Furthermore, the apparatus and methods described herein can be performed on any portion of multimedia data such as a block, macroblock, frame and superframe.

Encoder 205 selects one or more frames in the superframe to encode. In one embodiment, encoder 205 may use a scene change detection algorithm to detect and select one or more frames (e.g., one or more scene change frames) for each superframe of the multimedia data to be an acquisition point for I frame encoding and channel switch frame encoding (block 310). The selected frame for I frame encoding may or may not be the same as the selected frame for channel switch frame encoding. For example, frame 1 may be selected for I frame encoding and frame 7 may be selected for channel switch frame encoding. In this example, the collocated P frame is frame 1. Therefore, encoder 205 encodes frame 1 as an I frame and a P frame and frame 7 as a channel switch frame. In another embodiment, encoder 205 may select the same frame (e.g., frame 1) in the superframe for I frame encoding, channel switch frame encoding and P frame encoding.

As further discussed below, the selected frame may be encoded using a number of different encoding algorithms. For example, the selected frame may be encoded using three different encoding algorithms to produce encoded multimedia data such as a normal quality I frame, a channel switch frame (e.g., a low quality I frame), and a P frame. The channel switch frame and the normal quality P frame are collocated acquisition points. Encoder 205 adaptively determines whether and when to encode the one or more selected frames as an I frame, a channel switch frame and a P frame based on, for example, the coding efficiency, acquisition point, and packetization.

Encoder 205 encodes the multimedia data (e.g., the one or more selected frames) as an I frame (block 315). In one embodiment, encoder 205 uses an I frame encoding algorithm to encode the one or more selected frames as a normal quality I frame. For example, the normal quality I frame can have the same or similar quality as a previous neighboring frame to avoid beating effects or the quality being based on a rate control algorithm. The I frame encoding algorithm is used to produce an encoded I frame that has a normal quality.

Encoder 205 encodes the multimedia data (e.g., the one or more selected frames) as a channel switch frame (block 320). In one embodiment, encoder 205 uses a low quality I frame encoding algorithm to encode the one or more selected frames as a channel switch frame or a low quality I frame. By using a low quality I frame encoding algorithm, the quantization parameter (QP) of the channel switch frame can be increased by a certain value from the QP of the collocated P frame. The channel switch frame encoding algorithm is used to produce an encoded I frame that has a low quality.

Encoder 205 encodes the multimedia data (e.g., the one or more selected frames) as a P frame (block 325). In one embodiment, encoder 205 uses a P frame encoding algorithm to encode the one or more selected frames as a normal quality P frame. For example, the normal quality P frame can have the same or similar quality as a previous neighboring frame to avoid beating effects or the quality being based on a rate control algorithm. The P frame encoding algorithm is used to produce an encoded P frame that has a normal quality. At block 328, encoder 205 encodes one or more unselected frames (e.g., the remaining frames in the superframe) of the multimedia data as a P frame or a B frame.

In order to determine an efficient encoding algorithm for the multimedia data (e.g., the one or more selected frames), encoder 205 determines the size of the encoded I frame, the size of the encoded channel switch frame, and the size of the encoded P frame (block 330). Block 330 may be skipped if the size of the encoded I frame, the size of the encoded channel switch frame, and the size of the encoded P frame are determined during the encoding processes of blocks 315, 320 and 325.

Blocks 315, 320, 325 and 328 may be skipped as shown in FIG. 3A. If blocks 315, 320, 325 and 328 are skipped, encoder 205 sets a skip flag to 1 (block 333) indicating that encoder 205 has skipped the encoding of the multimedia data. If blocks 315, 320, 325 and 328 are skipped, encoder 205 estimates the size of the one or more selected frames if encoded as an I frame, the size of the one or more selected frames if encoded as a channel switch frame, and the size of the one or more selected frames if encoded as a P frame (block 330). In one embodiment, preprocessing is performed on the multimedia data (e.g., the one or more selected frames) by encoder 205 to estimate the size of the multimedia data based on spatial complexity and temporal complexity. The complexity metric of the multimedia data allows encoder 205 to estimate a size of the multimedia data if I frame encoding, channel switch frame encoding, and P frame encoding were to be performed on the multimedia data.

Once the sizes are determined or estimated, comparing module 210 compares the size of the encoded channel switch frame plus the encoded P frame to the size of the encoded I frame (block 335). By comparing the size of the normal quality I frame to the size of the low quality I frame and the normal quality P frame, comparing module 210 selects the most efficient encoding algorithm for the selected frame. In one embodiment, comparing module 210 may compare the superframe size of the encoded channel switch frame plus the encoded P frame to the superframe size of the encoded I frame. Comparing module 210 may transmit an encoding code for the selected frame to encoder 205. The encoding code represents the type of encoding to use for the selected frame.

At block 340, encoder 205 determines whether the skip flag is equal to 1. If the skip flag is equal to 1, encoder 205 needs to encode the one or more selected frames because the encoding was skipped. Encoder 205 encodes the one or more selected frames using I frame encoding (i.e., as a normal quality I frame) if the size of the I frame is less than the size of the channel switch frame plus the collocated P frame (block 345). Encoder 205 encodes the one or more selected frames using channel switch frame encoding (i.e., as a low quality I frame) and P frame encoding (i.e., as a normal quality P frame) if the size of the channel switch frame plus the P frame is less than the size of the I frame (block 350). The channel switch frame and the normal quality P frame are collocated as acquisition points. Hence, encoder 205 selects the encoding method that produces the least amount of bits or bytes. At block 355, encoder 205 encodes one or more unselected frames (e.g., the remaining frames in the superframe) of the multimedia data as a P frame or a B frame.

If the skip flag is not equal to 1, encoder 205 does not need to encode the one or more selected frames because the encoding was performed in blocks 315, 320, 325 and 328. Encoder 205 selects the encoded I frame if the size of the encoded I frame is less than the size of the encoded channel switch frame plus the encoded P frame (block 360). If the encoded I frame is selected, encoder 205 may discard the encoded channel switch frame and the encoded P frame. Encoder 205 selects the encoded channel switch frame and the encoded P frame if the size of the encoded channel switch frame plus the encoded P frame is less than the size of the encoded I frame (block 365). If the encoded channel switch frame and the encoded P frame are selected, encoder 205 may discard the encoded I frame.

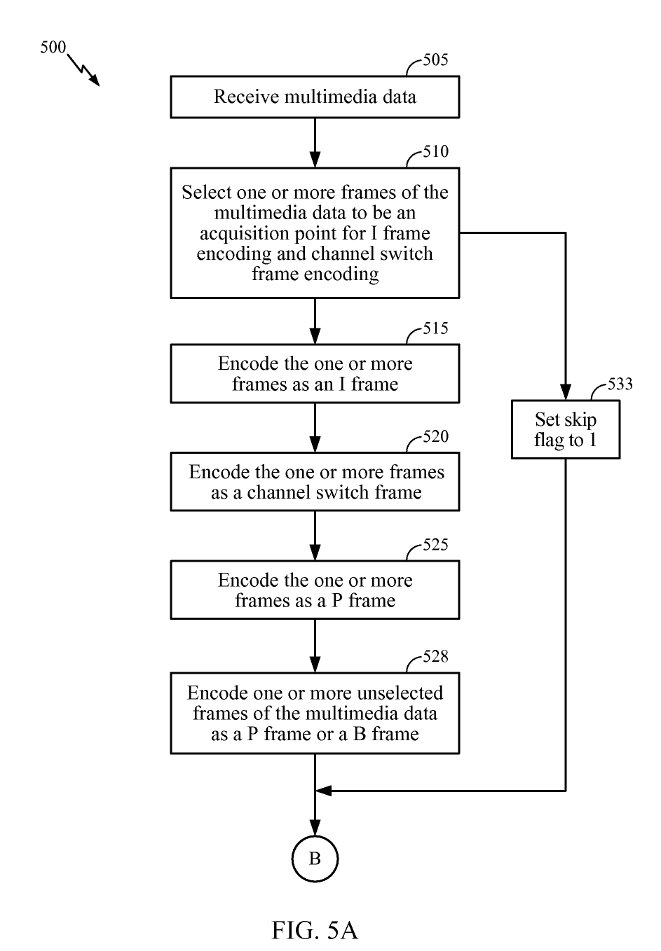

FIG. 4 is a block diagram of an encoding apparatus 400 configured to operate in a layered mode. In the layered mode, a base layer and an enhancement layer are used for processing the multimedia data. Encoding apparatus 400 may include an encoder 405, a balancing/padding module 410, a comparing module 415 and a packetizing module 420. A feedback loop 425 coupled between encoder 405 and comparing module 415 allows for multi-pass (e.g., 2 pass) encoding and transcoding. In multi-pass encoding or transcoding, encoder 405 has information about the complexity of each frame before the second pass encoding or reencoding. Encoding apparatus 400 may be substituted in place of or may be part of encoder 130 of FIG. 1.

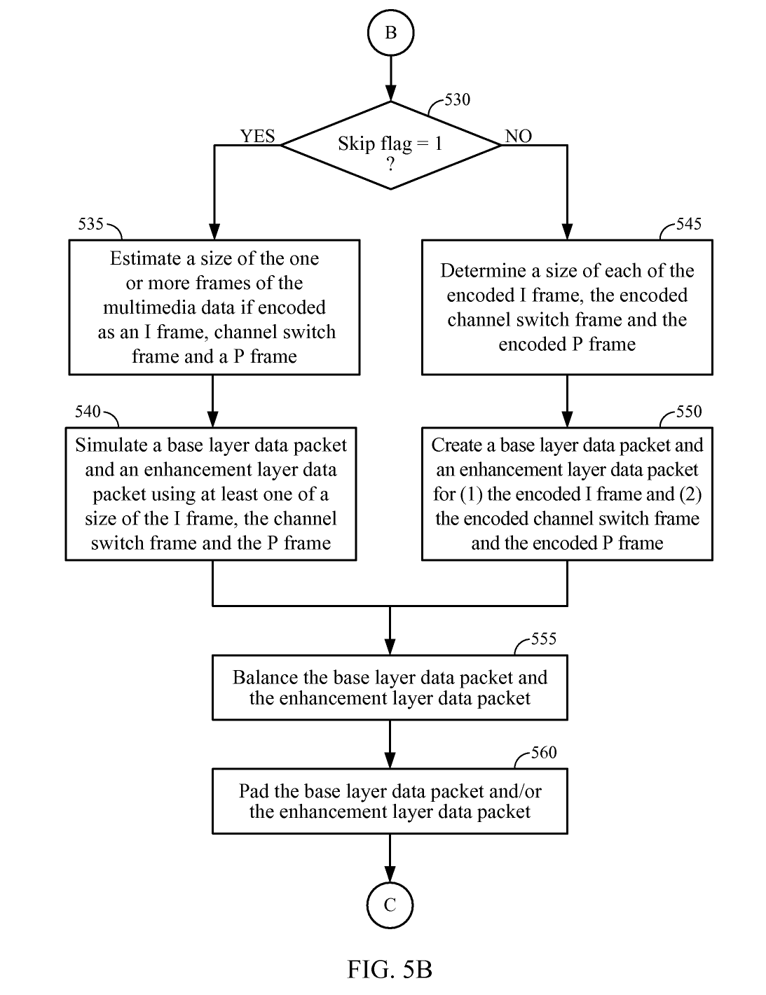

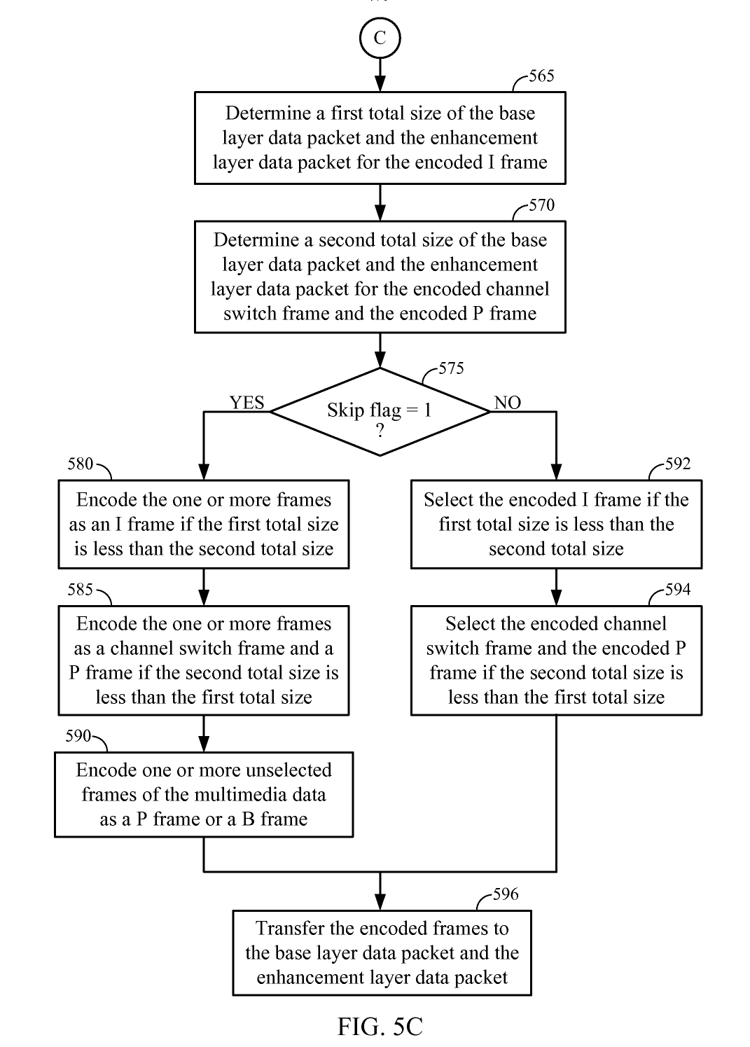

FIGS. 5A, 5B and 5C are a flow chart of a method of selecting multimedia data for acquisition in a layered mode. Referring to FIGS. 4, 5A, 5B and 5C, the multimedia data is received by encoder 405 in the form of a stream of bits (block 505). The stream of bits may be grouped or organized as one or more superframes. Encoder 405 selects a scene change frame in the superframe to encode. In one embodiment, encoder 405 may use a scene change detection algorithm to detect and select one or more frames (e.g., one or more scene change frames) for each superframe of the multimedia data that are acquisition points for I frame encoding and channel switch frame encoding (block 510). The selected frame for I frame encoding may or may not be the same as the selected frame for channel switch frame encoding.

As further discussed below, the selected frame may be encoded using a number of different encoding algorithms. For example, the selected frame may be encoded using three different encoding algorithms to produce encoded multimedia data such as a normal quality I frame, a channel switch frame (e.g., a low quality I frame), and a P frame. The channel switch frame and the normal quality P frame are collocated acquisition points. Encoder 405 adaptively determines whether and when to encode the one or more selected frames as an I frame, a channel switch frame and a P frame based on, for example, the coding efficiency, acquisition point, and packetization.

Encoder 405 encodes the multimedia data (e.g., the one or more selected frames) as an I frame (block 515). In one embodiment, encoder 405 uses an I frame encoding algorithm to encode the one or more selected frames as a normal quality I frame. For example, the normal quality I frame can have the same or similar quality as a previous neighboring frame to avoid beating effects or the quality being based on a rate control algorithm. The I frame encoding algorithm is used to produce an encoded I frame that has a normal quality.

Encoder 405 encodes the multimedia data (e.g., the one or more selected frames) as a channel switch frame (block 520). In one embodiment, encoder 405 uses a low quality I frame encoding algorithm to encode the one or more selected frames as a channel switch frame or a low quality I frame. By using a low quality I frame encoding algorithm, the quantization parameter (QP) of the channel switch frame can be increased by a certain value from the QP of the collocated P frame. The channel switch frame encoding algorithm is used to produce an encoded I frame that has a low quality.

Encoder 405 encodes the multimedia data (e.g., the one or more selected frames) as a P frame (block 525). In one embodiment, encoder 405 uses a P frame encoding algorithm to encode the one or more selected frames as a normal quality P frame. For example, the normal quality P frame can have the same or similar quality as a previous neighboring frame to avoid beating effects or the quality being based on a rate control algorithm. The P frame encoding algorithm is used to produce an encoded P frame that has a normal quality. At block 528, encoder 405 encodes one or more unselected frames (e.g., the remaining frames in the superframe) of the multimedia data as a P frame or a B frame.

Blocks 515, 520, 525 and 528 may be skipped as shown in FIG. 5A. If blocks 515, 520, 525 and 528 are skipped, encoder 405 sets a skip flag to 1 (block 533) indicating that encoder 405 has skipped the encoding of the multimedia data.

At block 530, encoder 405 determines whether the skip flag is equal to 1. If the skip flag is equal to 1, encoder 405 estimates the size of the one or more selected frames if encoded as an I frame, the size of the one or more selected frames if encoded as a channel switch frame, and the size of the one or more selected frames if encoded as a P frame (block 535). In one embodiment, preprocessing is performed on the multimedia data (e.g., the one or more selected frames) by encoder 405 to estimate the size of the multimedia data based on spatial complexity and temporal complexity. The complexity metric of the multimedia data allows encoder 405 to estimate a size of the multimedia data if I frame encoding, channel switch frame encoding, and P frame encoding were to be performed on the multimedia data.

Since the multimedia data has not been encoded, encoder 405 simulates a base layer data packet and an enhancement layer data packet using at least one of a size of the multimedia data if I frame encoding, channel switch frame encoding, and P frame encoding were to be performed on the multimedia data (block 540). The size of the multimedia data allows encoder 405 to predict the contents of the base layer data packet and the enhancement layer data packet.

If the skip flag is not equal to 1, encoder 405 determines the size of the encoded I frame, the size of the encoded channel switch frame, and the size of the encoded P frame (block 545). Block 545 may be skipped if the size of the encoded I frame, the size of the encoded channel switch frame, and the size of the encoded P frame were determined during the encoding processes of blocks 515, 520 and 525.

Since the multimedia data has been encoded, encoder 405 creates a base layer data packet and an enhancement layer data packet for (1) the encoded I frame and (2) the encoded channel switch frame and the encoded P frame (block 550). Therefore, encoder 405 creates two base layer data packets and two enhancement layer data packets. That is, one base layer data packet and one enhancement layer data packet for 1 frame encoding and one base layer data packet and one enhancement layer data packet for channel switch frame and P frame encoding.

Balancing/padding module 410 balances the base layer data packet and the enhancement layer data packet so they are the same size (block 555). If the size of the base layer is different from the size of the enhancement layer, balancing/padding module 410 may move or transfer frames or portions of frames from the larger layer to the smaller layer in an attempt to make the two layers similar in size. In one embodiment, balancing/padding module 410 selects B frames or P frames to move or transfer from one layer to another layer. The balancing reduces the number of padding bits or bytes. Once the balancing is complete, balancing/padding module 410 determines the size of the base layer and the size of the enhancement layer and fills or pads the smaller layer so that it is equal to the larger layer (block 560).

Comparing module 415 calculates or determines a first total size of the base layer plus the enhancement layer for the normal quality I frame (block 565). Comparing module 415 calculates or determines a second total size of the base layer plus the enhancement layer for the low quality I frame and the normal quality P frame (570).

At block 575, encoder 405 determines whether the skip flag is equal to 1. If the skip flag is equal to 1, encoder 405 needs to encode the one or more selected frames because the encoding was skipped. Encoder 405 encodes the one or more selected frames using I frame encoding (i.e., as a normal quality I frame) if the size of the I frame is less than the size of the channel switch frame plus the collocated P frame (block 580). Encoder 405 encodes the one or more selected frames using channel switch frame encoding (i.e., as a low quality I frame) and P frame encoding (i.e., as a normal quality P frame) if the size of the channel switch frame plus the P frame is less than the size of the I frame (block 585). The channel switch frame and the normal quality P frame are collocated as acquisition points. At block 590, encoder 405 encodes one or more unselected frames (e.g., the remaining frames in the superframe) of the multimedia data as a P frame or a B frame.

If the skip flag is not equal to 1, encoder 405 does not need to encode the one or more selected frames because the encoding was performed in blocks 515, 520 and 525. Encoder 405 selects the base layer data packet and the enhancement layer data packet of the encoded I frame if the first total size is less than the second total size (block 592). If the encoded I frame is selected, encoder 405 may discard the base layer data packet and the enhancement layer data packet for the encoded channel switch frame and the encoded P frame. Encoder 405 selects the base layer data packet and the enhancement layer data packet of the encoded channel switch frame and the encoded P frame if the second total size is less than the first total size (block 594). If the encoded channel switch frame and the encoded P frame are selected, encoder 405 may discard the base layer data packet and the enhancement layer data packet for the encoded I frame. Hence, encoder 405 selects the encoding method that produces the smallest size for the base layer plus the enhancement layer. Packetizing module 420 may transfer the encoded frames to the base layer data packet and the enhancement layer data packet (block 596).

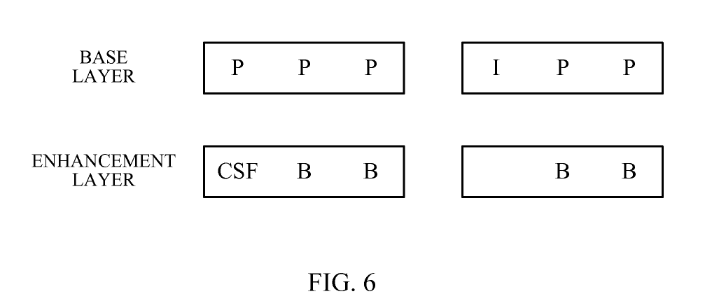

FIG. 6 is an exemplary base layer and enhancement layer configurations based on the encoding method. In one embodiment, the first base layer may have an initial P frame and the first enhancement layer may have a collocated channel switch frame and the second base layer may have an initial I frame and the second enhancement layer may have padded bits.

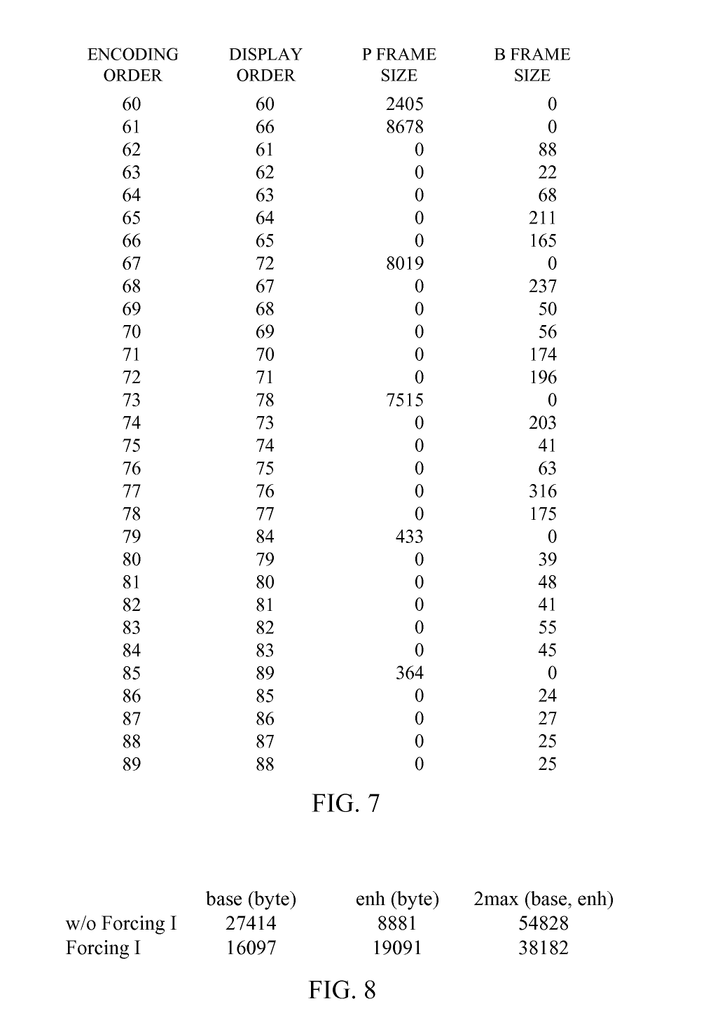

FIG. 7 is a table illustrating an encoding order, a display order, a P frame size, and a B frame size for a number of encoded frames. If the base layer has no I frame, all P frames are sent to the base layer. If the base layer has an I frame, an I frame or a P frame in front of it (based on display order) can be sent to the base layer or the enhancement layer.

FIG. 8 is a table illustrating the number of bytes produced in the base layer and the enhancement layer when forcing a normal I frame encoding method and without forcing a normal I frame encoding method. The frame numbers mentioned in the following are based on encoding order. The channel switch frame corresponding to frame 60 has 6,487 bytes. Since the base layer and the enhancement layer are to be the same size, when the I frame is not forced, encoder 405 sends all P frames to the base layer and all B frames and channel switch frames to the enhancement layer. The enhancement layer (8,881 bytes) is padded with stuffing bytes so that it is equal in size to the base layer (27,414 bytes). When the I frame with 13,692 bytes is forced at frame 73 (the P frame at frame 73 is discarded), encoder 405 sends frames 60, 73, 79 and 85 to the base layer and the remaining P frames and all B frames are sent to the enhancement layer. The base layer (16,097 bytes) is padded with stuffing bytes so that it is equal in size to the enhancement layer (19,091 bytes). As shown in FIG. 8, without forcing the I frame, the encoding method results in a first total size of 54,828 bytes. However, by forcing the I frame, the encoding method results in a second total size of 38,182 bytes. Hence, encoder 405 selects the encoding method that forces the encoding using a normal quality I frame because the saving in the number of bytes.

In some embodiments of the invention, an apparatus for processing multimedia data is disclosed. The apparatus may include means for encoding multimedia data as an I frame, a channel switch frame, and a P frame. The means for encoding multimedia data may be processor 120, encoder 130, encoder 205 and/or encoder 405. The apparatus may include means for selecting the encoded multimedia data. The means for selecting may be processor 120, encoder 130, encoder 205, comparing module 210, encoder 405 and/or comparing module 415. The apparatus may include means for balancing a first base layer data packet to be a similar size as a first enhancement layer data packet and balancing a second base layer data packet to be a similar size as a second enhancement layer data packet. The means for balancing may be processor 120, encoder 130, encoder 205, comparing module 210, encoder 405, balancing/padding module 410 and/or comparing module 415. The apparatus may include means for padding the first base layer data packet to be the same size as the first enhancement layer data packet and padding the second base layer data packet to be the same size as the second enhancement layer data packet. The means for padding may be processor 120, encoder 130, encoder 205, comparing module 210, encoder 405, balancing/padding module 410 and/or comparing module 415.

Those of ordinary skill would appreciate that the various illustrative logical blocks, modules, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosed methods.

The various illustrative logical blocks, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit (ASIC). The ASIC may reside in a wireless modem. In the alternative, the processor and the storage medium may reside as discrete components in the wireless modem.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. A method of processing multimedia data comprising:
encoding a frame of the multimedia data as an I frame, a channel switch frame, and a P frame; and
selecting the encoded I frame if a size of the encoded I frame and a size of the encoded channel switch frame and the encoded P frame meet a first condition.

2. The method of claim 1 wherein the first condition is met if the size of the encoded I frame is less than the size of the encoded channel switch frame plus the encoded P frame.

3. The method of claim 1 further comprising selecting the encoded channel frame and the encoded P frame if the size of the encoded I frame and the size of the encoded channel switch frame and the encoded P frame meet a second condition.

4. The method of claim 3 wherein the second condition is met if the size of the encoded channel switch frame and the encoded P frame is less than the size of the encoded I frame.

5. The method of claim 1 wherein encoding a frame comprises encoding a first frame as an I frame and encoding a second frame as a channel switch frame.

6. The method of claim 1 further comprising estimating the size of the encoded I frame and the size of the encoded channel switch frame and the encoded P frame based on spatial complexity and temporal complexity.

7. The method of claim 1 further comprising:
encoding a frame of the multimedia data as a B frame;
creating a first base layer data packet and a first enhancement layer data packet using at least one of the encoded I frame or the encoded B frame; and
creating a second base layer data packet and a second enhancement layer data packet using at least one of the encoded P frame or the encoded channel switch frame.

8. The method of claim 7 further comprising balancing the first base layer data packet to be a similar size as the first enhancement layer data packet and balancing the second base layer data packet to be a similar size as the second enhancement layer data packet.

9. The method of claim 8 further comprising padding the first base layer data packet to be the same size as the first enhancement layer data packet and padding the second base layer data packet to be the same size as the second enhancement layer data packet.

10. The method of claim 9 further comprising:
determining a first total size of the first base layer data packet and the first enhancement layer data packet;
assigning the first total size to the size of the encoded I frame;
determining a second total size of the second base layer data packet and the second enhancement layer data packet; and
assigning the second total size to the size of the encoded channel switch frame and the encoded P frame.

11. An apparatus for processing multimedia data comprising:
an encoder for encoding a frame of the multimedia data as an I frame, a channel switch frame, and a P frame and selecting the encoded I frame if a size of the encoded I frame and a size of the encoded channel switch frame and the encoded P frame meet a first condition.

12. The apparatus of claim 11 wherein the first condition is met if the size of the encoded I frame is less than the size of the encoded channel switch frame plus the encoded P frame.

13. The apparatus of claim 11 wherein the encoder selects the encoded channel frame and the encoded P frame if the size of the encoded I frame and the size of the encoded channel switch frame and the encoded P frame meet a second condition.

14. The apparatus of claim 13 wherein the second condition is met if the size of the encoded channel switch frame and the encoded P frame is less than the size of the encoded I frame.

15. The apparatus of claim 11 wherein encoding a frame comprises encoding a first frame as an I frame and encoding a second frame as a channel switch frame.

16. The apparatus of claim 11 wherein the encoder estimates the size of the encoded I frame and the size of the encoded channel switch frame and the encoded P frame based on spatial complexity and temporal complexity.

17. The apparatus of claim 11 wherein the encoder:
encodes a frame of the multimedia data as a B frame;
creates a first base layer data packet and a first enhancement layer data packet using at least one of the encoded I frame or the encoded B frame; and
creates a second base layer data packet and a second enhancement layer data packet using at least one of the encoded P frame or the encoded channel switch frame.

18. The apparatus of claim 17 further comprising a balancing module for balancing the first base layer data packet to be a similar size as the first enhancement layer data packet and balancing the second base layer data packet to be a similar size as the second enhancement layer data packet.

19. The apparatus of claim 18 further comprising a padding module for padding the first base layer data packet to be the same size as the first enhancement layer data packet and padding the second base layer data packet to be the same size as the second enhancement layer data packet.

20. The apparatus of claim 19 wherein the encoder:
determines a first total size of the first base layer data packet and the first enhancement layer data packet;
assigns the first total size to the size of the encoded I frame;
determines a second total size of the second base layer data packet and the second enhancement layer data packet; and
assigns the second total size to the size of the encoded channel switch frame and the encoded P frame.

21. An apparatus for processing multimedia data comprising:
means for encoding a frame of the multimedia data as an I frame, a channel switch frame, and a P frame; and
means for selecting the encoded I frame if a size of the encoded I frame and a size of the encoded channel switch frame and the encoded P frame meet a first condition.

22. The apparatus of claim 21 wherein the first condition is met if the size of the encoded I frame is less than the size of the encoded channel switch frame plus the encoded P frame.

23. The apparatus of claim 21 wherein the means for selecting selects the encoded channel frame and the encoded P frame if the size of the encoded I frame and the size of the encoded channel switch frame and the encoded P frame meet a second condition.

24. The apparatus of claim 23 wherein the second condition is met if the size of the encoded channel switch frame and the encoded P frame is less than the size of the encoded I frame.

25. The apparatus of claim 21 wherein encoding a frame comprises encoding a first frame as an I frame and encoding a second frame as a channel switch frame.

26. The apparatus of claim 21 wherein the means for encoding estimates the size of the encoded I frame and the size of the encoded channel switch frame and the encoded P frame based on spatial complexity and temporal complexity.

27. The apparatus of claim 21 wherein the means for encoding:
encodes a frame of the multimedia data as a B frame;
creates a first base layer data packet and a first enhancement layer data packet using at least one of the encoded I frame or the encoded B frame; and
creates a second base layer data packet and a second enhancement layer data packet using at least one of the encoded P frame or the encoded channel switch frame.

28. The apparatus of claim 27 further comprising means for balancing the first base layer data packet to be a similar size as the first enhancement layer data packet and balancing the second base layer data packet to be a similar size as the second enhancement layer data packet.

29. The apparatus of claim 28 further comprising means for padding the first base layer data packet to be the same size as the first enhancement layer data packet and padding the second base layer data packet to be the same size as the second enhancement layer data packet.

30. The apparatus of claim 29 wherein the means for encoding:
determines a first total size of the first base layer data packet and the first enhancement layer data packet;
assigns the first total size to the size of the encoded I frame;
determines a second total size of the second base layer data packet and the second enhancement layer data packet; and
assigns the second total size to the size of the encoded channel switch frame and the encoded P frame.

31. A machine-readable medium comprising instructions for processing multimedia data, the instructions upon execution cause a machine to:
encode a frame of the multimedia data as an I frame, a channel switch frame, and a P frame; and
select the encoded I frame if a size of the encoded I frame and a size of the encoded channel switch frame and the encoded P frame meet a first condition.

32. The machine-readable medium of claim 31 wherein the first condition is met if the size of the encoded I frame is less than the size of the encoded channel switch frame plus the encoded P frame.

33. The machine-readable medium of claim 31 further comprising instructions to select the encoded channel frame and the encoded P frame if the size of the encoded I frame and the size of the encoded channel switch frame and the encoded P frame meet a second condition.

34. The machine-readable medium of claim 33 wherein the second condition is met if the size of the encoded channel switch frame and the encoded P frame is less than the size of the encoded I frame.

35. The machine-readable medium of claim 31 wherein encode a frame comprises encode a first frame as an I frame and encoding a second frame as a channel switch frame.

36. The machine-readable medium of claim 31 further comprising instructions to estimate the size of the encoded I frame and the size of the encoded channel switch frame and the encoded P frame based on spatial complexity and temporal complexity.

37. The machine-readable medium of claim 31 further comprising instructions to:
encode a frame of the multimedia data as a B frame;
create a first base layer data packet and a first enhancement layer data packet using at least one of the encoded I frame or the encoded B frame; and
create a second base layer data packet and a second enhancement layer data packet using at least one of the encoded P frame or the encoded channel switch frame.

38. The machine-readable medium of claim 37 further comprising instructions to balance the first base layer data packet to be a similar size as the first enhancement layer data packet and balance the second base layer data packet to be a similar size as the second enhancement layer data packet.

39. The machine-readable medium of claim 38 further comprising instructions to pad the first base layer data packet to be the same size as the first enhancement layer data packet and pad the second base layer data packet to be the same size as the second enhancement layer data packet.

40. The machine-readable medium of claim 39 further comprising instructions to:
determine a first total size of the first base layer data packet and the first enhancement layer data packet;
assign the first total size to the size of the encoded I frame;
determine a second total size of the second base layer data packet and the second enhancement layer data packet; and
assign the second total size to the size of the encoded channel switch frame and the encoded P frame.

41. A handset for processing multimedia data comprising:
an encoder for encoding a frame of the multimedia data as an I frame, a channel switch frame, and a P frame and selecting the encoded I frame if a size of the encoded I frame and a size of the encoded channel switch frame and the encoded P frame meet a first condition.

42. The handset of claim 41 wherein the first condition is met if the size of the encoded I frame is less than the size of the encoded channel switch frame plus the encoded P frame.

43. The handset of claim 41 wherein the encoder selects the encoded channel frame and the encoded P frame if the size of the encoded I frame and the size of the encoded channel switch frame and the encoded P frame meet a second condition.

44. The handset of claim 43 wherein the second condition is met if the size of the encoded channel switch frame and the encoded P frame is less than the size of the encoded I frame.

45. The handset of claim 41 wherein encoding a frame comprises encoding a first frame as an I frame and encoding a second frame as a channel switch frame.

46. The handset of claim 41 wherein the encoder estimates the size of the encoded I frame and the size of the encoded channel switch frame and the encoded P frame based on spatial complexity and temporal complexity.

47. The handset of claim 41 wherein the encoder:
encodes a frame of the multimedia data as a B frame;
creates a first base layer data packet and a first enhancement layer data packet using at least one of the encoded I frame or the encoded B frame; and
creates a second base layer data packet and a second enhancement layer data packet using at least one of the encoded P frame or the encoded channel switch frame.

48. The handset of claim 47 further comprising a balancing module for balancing the first base layer data packet to be a similar size as the first enhancement layer data packet and balancing the second base layer data packet to be a similar size as the second enhancement layer data packet.

49. The handset of claim 48 further comprising a padding module for padding the first base layer data packet to be the same size as the first enhancement layer data packet and padding the second base layer data packet to be the same size as the second enhancement layer data packet.

50. The handset of claim 49 wherein the encoder:
determines a first total size of the first base layer data packet and the first enhancement layer data packet;
assigns the first total size to the size of the encoded I frame;
determines a second total size of the second base layer data packet and the second enhancement layer data packet; and
assigns the second total size to the size of the encoded channel switch frame and the encoded P frame.

51. An integrated circuit for processing multimedia data comprising:
an encoding circuit for encoding a frame of the multimedia data as an I frame, a channel switch frame, and a P frame and selecting the encoded I frame if a size of the encoded I frame and a size of the encoded channel switch frame and the encoded P frame meet a first condition.

52. The integrated circuit of claim 51 wherein the first condition is met if the size of the encoded I frame is less than the size of the encoded channel switch frame plus the encoded P frame.

53. The integrated circuit of claim 51 wherein the encoding circuit selects the encoded channel frame and the encoded P frame if the size of the encoded I frame and the size of the encoded channel switch frame and the encoded P frame meet a second condition.

54. The integrated circuit of claim 53 wherein the second condition is met if the size of the encoded channel switch frame and the encoded P frame is less than the size of the encoded I frame.

55. The integrated circuit of claim 51 wherein encoding a frame comprises encoding a first frame as an I frame and encoding a second frame as a channel switch frame.

56. The integrated circuit of claim 51 wherein the encoding circuit estimates the size of the encoded I frame and the size of the encoded channel switch frame and the encoded P frame based on spatial complexity and temporal complexity.

57. The integrated circuit of claim 51 wherein the encoding circuit:
encodes a frame of the multimedia data as a B frame;
creates a first base layer data packet and a first enhancement layer data packet using at least one of the encoded I frame or the encoded B frame; and
creates a second base layer data packet and a second enhancement layer data packet using at least one of the encoded P frame or the encoded channel switch frame.

58. The integrated circuit of claim 57 further comprising a balancing circuit for balancing the first base layer data packet to be a similar size as the first enhancement layer data packet and balancing the second base layer data packet to be a similar size as the second enhancement layer data packet.

59. The integrated circuit of claim 58 further comprising a padding circuit for padding the first base layer data packet to be the same size as the first enhancement layer data packet and padding the second base layer data packet to be the same size as the second enhancement layer data packet.

60. The integrated circuit of claim 59 wherein the encoding circuit:
determines a first total size of the first base layer data packet and the first enhancement layer data packet;
assigns the first total size to the size of the encoded I frame;
determines a second total size of the second base layer data packet and the second enhancement layer data packet; and
assigns the second total size to the size of the encoded channel switch frame and the encoded P frame.
